(19) United States
(12) Patent Application Publication
(10) Pub. No.: US 2015/0050380 A1
(43) Pub. Date: Feb. 19, 2015

(54) VACUUM TOOLING APPARATUS AND METHOD

(71) Applicant: Gregory A. Shteyngarts, Solon, OH (US)

(72) Inventor: Gregory A. Shteyngarts, Solon, OH (US)

(21) Appl. No.: 14/461,997

(22) Filed: Aug. 18, 2014

Related U.S. Application Data
(60) Provisional application No. 61/867,295, filed on Aug. 19, 2013.

(51) Int. Cl. B29C 51/20

(52) U.S. Cl. CPC B29C 51/20; B29L 2031/768
USPC 425/504

(57) ABSTRACT

A new and improved method and apparatus for producing a temporary wheel protective cover or shield which can be temporarily installed on the wheel of the vehicle to protect it during the time interval between its manufacture date and its delivery to a customer. A tooling apparatus is used to form a cylindrical hub portion in the protective cover which includes a hub forming member, a reciprocally movable operating member slidably supported by a hub and a camming element operatively attached to the operating member. A plurality of radially extendable fingers are held in associated pockets and each of the fingers defines a cam contact surface abutably engageable with the camming element such that movement of the camming element towards the cam contact surfaces defined by the fingers, urges the fingers radially outwardly. When the camming element moves away from the finger cam contact surfaces, the fingers are allowed to retract in order to release the molded hub portion of the protective cover.

### RELATED APPLICATION

This application claims the benefit of U.S. Provisional Patent Application Ser. No. 61/867,295, filed on Aug. 19, 2013, the disclosure of which is entirely incorporated herein by reference.

### TECHNICAL FIELD

The present invention relates generally to vacuum formed products and a vacuum forming process and, in particular, to a method and apparatus for vacuum forming a protective cover or shield for a vehicle wheel.

### BACKGROUND ART

Automobile manufacturers often take steps to protect the exterior of a newly manufactured vehicle during transit from the factory to a dealer. Protective coatings or sheets of material are often are installed on exterior panels of the vehicle in an effort to prevent damage to the panels. Manufacturers also desire to protect the exterior of the vehicle's wheels during transit. Many of the wheels used on today's automobile vehicles are expensive alloy castings or forgings. Replacing a wheel damaged during transit can be expensive.

### SUMMARY OF INVENTION

The present invention provides a new and improved method and apparatus for producing a temporary wheel protective cover or shield which can be temporarily installed on the wheel of the vehicle to protect it during the time interval between its manufacture date and its delivery to a customer.

According to the invention, the protective wheel cover or shield is vacuum formed on tooling constructed in accordance with the invention. The tooling is operative to form radially extending projections or grippers on a hub portion of the shield. The projections are releasably engageable with a center hole formed in the wheel. The projections so formed, are capable of maintaining the position of the shield on the wheel during vehicle transit but allow the shield to be readily removed upon delivery to the customer.

According to the invention, the tool includes retractable teeth or fingers which extend outwardly during the molding process to form the radially extending projections on the hub portion of the shield but which retract at the conclusion of the molding cycle to allow the shield to be released by the mold.

According to the invention, the disclosed tooling apparatus is used to form a cylindrical hub portion in a protective cover. The apparatus includes a hub-forming member that is secured to a base. A reciprocally movable operating member is slidably supported by the hub and/or the base. A camming element is operatively attached to the operating member. A plurality of radially extending fingers is loosely held in associated pockets defined by the hub. Each of the fingers define a cam contact surface that is abutably engageable with the camming element such that movement of the camming element towards the cam contact surfaces urges the fingers radially outwardly to thereby form projections during the molding process of the protective cover. The camming element is further operative such that when it moves away from the cam contact surfaces, the fingers are allowed to retract to thereby release the molded hub portion of the protective cover that is molded by the tooling. In other words, when the camming element is moved towards the cam contact surfaces, the fingers are urged outwardly by virtue of being squeezed between the camming element and a camming surface defined by each finger receiving pocket.

In the preferred embodiment, the camming element is spring biased towards contact with the cam contact surfaces of the fingers.

According to another feature of the invention, each finger is held in its associated hub pocket using a fastener that allows each finger to move radially and axially as the finger moves from a retracted position to an extended position. According to a further aspect of this feature, each finger retaining fastener extends through a bore defined by the hub portion. Each bore defines a radial clearance between a shaft of the finger retaining fastener and the bore to provide a first clearance. In the preferred and illustrated embodiment, each finger fastener is arranged to provide a clearance between an underside of a retention head of the fastener and an end face of the bore.

According to still another feature of the invention, the camming element includes a frusto-conical camming surface.

Additional features of the invention will become apparent and a fuller understanding obtained by reading the following detailed description made in connection with the accompanying drawings.

### BRIEF DESCRIPTION OF DRAWINGS

FIG. 1 is a partially exploded view showing the mold and wheel shield (vacuum formed and the associated tooling used to form the shield;

FIG. 2 is an exploded view of the portion of the tooling shown in FIG. 1 that is used to form a hub section in the wheel shield;

FIG. 3 is an isometric, partially sectioned view of the tool portion that is used to form the hub in the wheel shield;

FIG. 4 is a sectional view of the tool portion shown in a position in which the radial projections are formed in the wheel shield; and

FIG. 5 is a sectional view of the tool portion showing it in a position at which teeth/projections are retracted in order to allow the release of a formed wheel shield from the tooling.

### DESCRIPTION OF THE PREFERRED EMBODIMENT

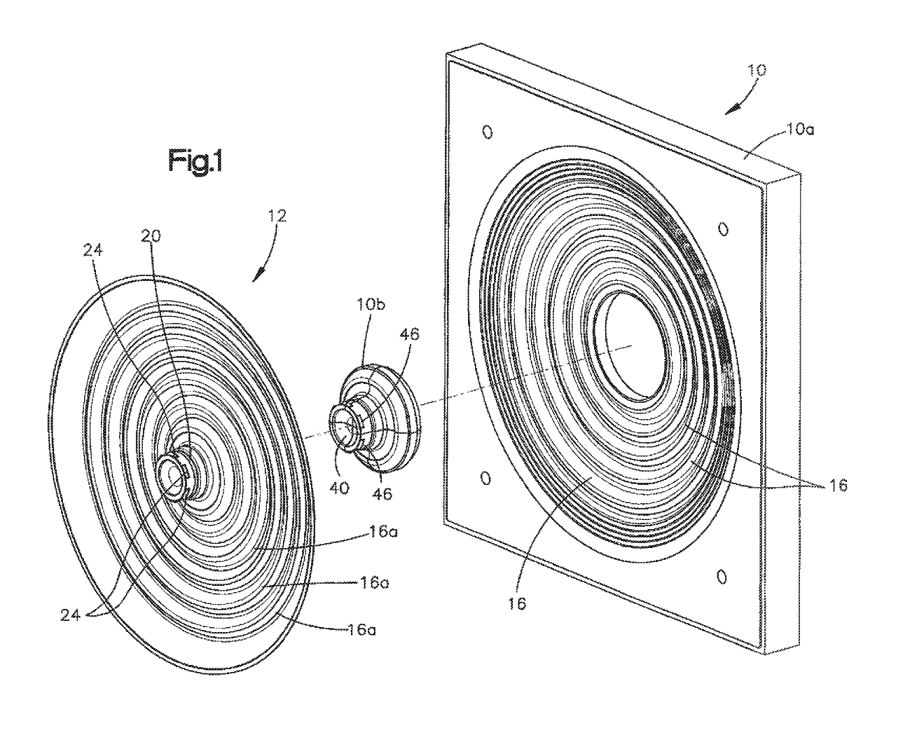

FIG. 1 illustrates the overall construction of a vacuum tooling or mold 10 constructed in accordance with a preferred embodiment of the invention and also showing a wheel protective cover 12 which can be formed by the tooling 10. According to the invention, the vacuum tooling includes a base plate 10a and a hub forming tool portion 10b. The base plate 10 shown in FIG. 1 is considered conventional and includes a plurality of annular grooves 16 which, during the molding process form associated annular, rigidizing ribs 16a in the wheel shield 12. The base plate includes a center opening 18 which receives the hub portion 10b of the molding tooling. The hub portion tooling 10b extends axially from the base plate 10a and preferably has a center axis that is coincident with an axis 17 of the center hole 18 and annular rib forming grooves 16 of the base plate 10a. The hub portion tooling 10b forms a centrally located, cylindrical hub 20 in the wheel protective cover or shield 12. As seen best in FIG. 1, the cylindrical hub 20 includes a plurality of radially extending projections or grippers 24. The projections 24 are operative to grip the inside surface of a center hole/bore of a wheel to be protected (not shown) when the hub is inserted into the center opening of the wheel (not shown).

The shield 12 is preferably formed from a deformable plastic material such as polyvinyl chloride (PVC) so that the projections 24 resiliently or elastically grip the inside surface of the wheel opening and are elastically deformable so that, if sufficient, a force is applied to the wheel protective cover 12, it can be removed from the wheel prior to delivery to the customer.

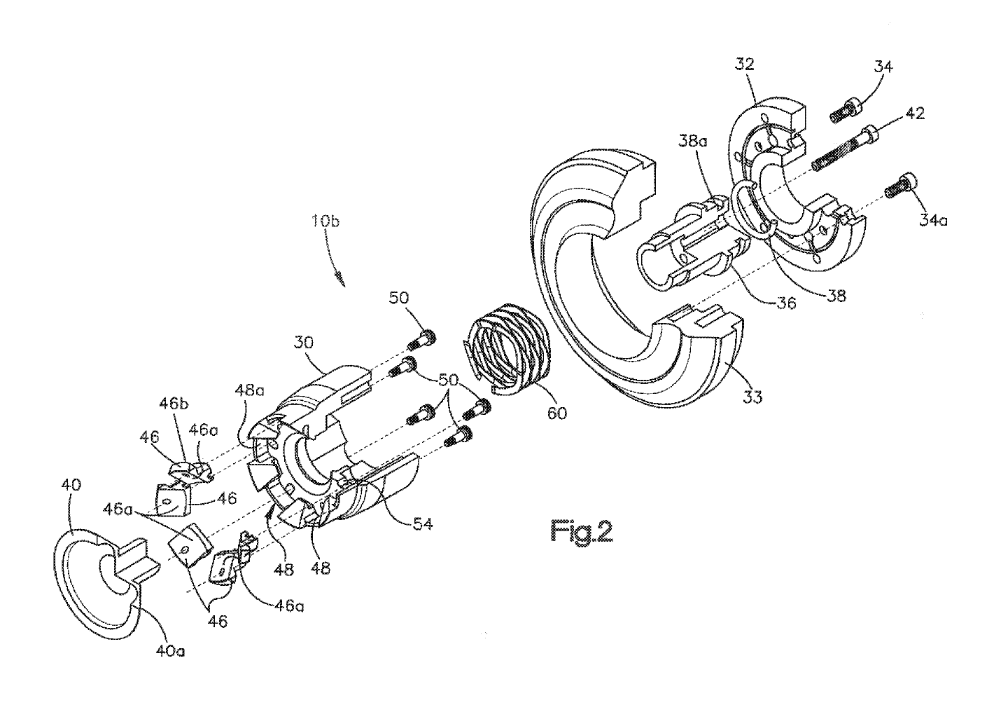

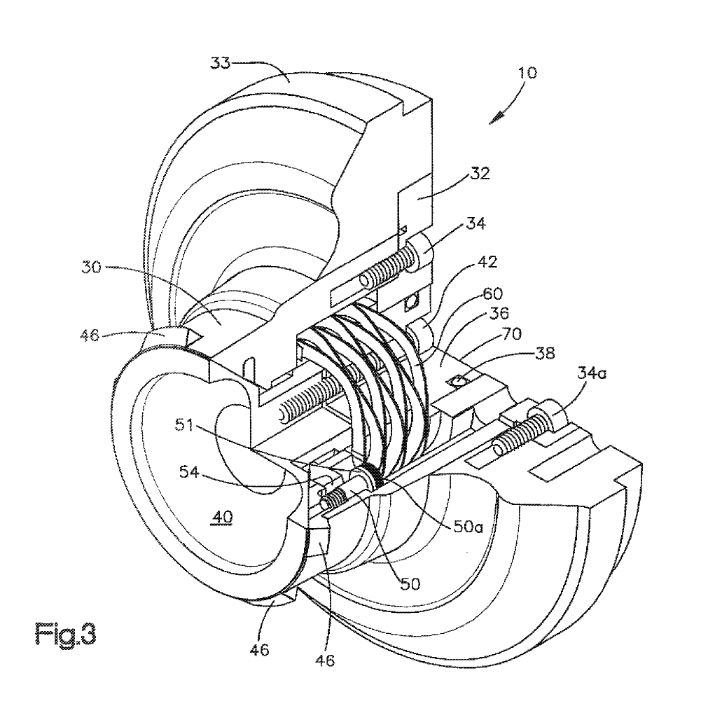

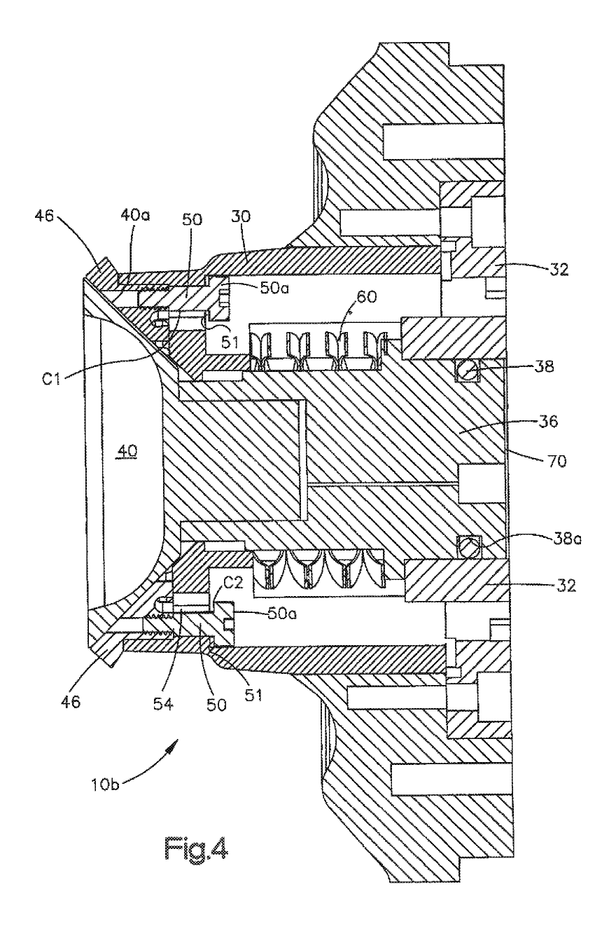

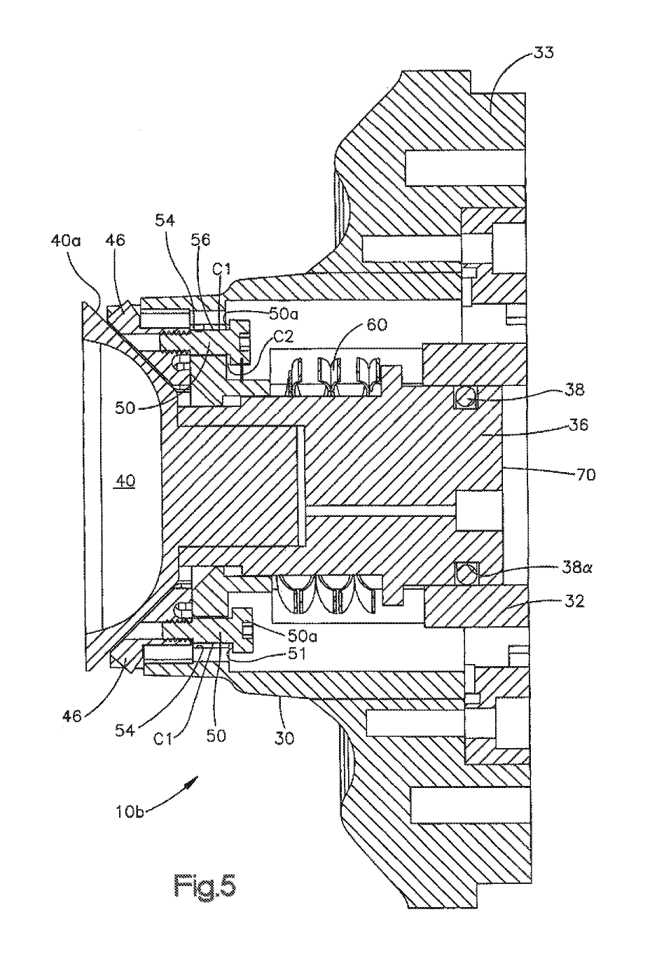

Referring to FIGS. 2 and 3, the construction of the hub portion 10b of the vacuum tooling 10 is illustrated. The hub portion 10b includes a hub forming segment 30. This portion of the tool forms the cylindrical hub 20 of the protective cover or shield 12 (see FIG. 1). The hub 30 is suitably attached to a sub-base plate 32 by a plurality of threaded fasteners 34. A piston or actuating pin 36 is slidably supported between the hub portion 30 and the annular sub-base plate 34 (shown best in FIGS. 4 and 5).

Referring also to FIG. 3, the sub-base plate 32 is secured to an annular, outer base member 33 by a plurality of threaded fasteners 34a. As will be explained, the piston 36 is slidably movable towards the left and right, as viewed in FIG. 4. An O-ring or other suitable annular seal 38 is located in an annular O-ring groove 38a and inhibits air/vacuum leakage between the piston 36 and the sub-base plate 32 and/or hub 30.

A camming element or cone 40 is secured to the operating piston 36 by a plurality of threaded fasteners 42 (only one shown). A plurality of teeth/fingers 46 are slidably held in associated slots or pockets 48 formed in the hub portion 30 of the tooling 10b. The teeth are loosely held within the slots by associated threaded fasteners 50. Each pocket also includes a camming surface 48a which is abutably engageable by a finger cam surface 46b. The surfaces 46a and 46b are radiused and conform to the camming surfaces 40a, 48a which are also radiused or arcuate. With the disclosed construction, when a finger 46 is squeezed between the camming element surface 40a and the pocket surface 48a, the finger 46 is urged radially outwardly. When the camming element 40 is moved away from the pockets 48, the fingers 46 are released and are allowed to retract as the molded hub portion of the protective cover is pulled from the mold.

Referring to FIGS. 4 and 5, the teeth 46 are loosely coupled to the hub member 30 by the associated fasteners 50 which each extend through an enlarged or slotted hole 54 formed in the hub member 30. As will be explained, each tooth 46 can move between an extended position shown in FIG. 4 to a retracted position shown in FIG. 5. Not only is clearance c1 provided in the hub member hole 54 that receives the screw 50, but a clearance c2 is maintained between an underside 51 of a screw head 50a and an abutment surface formed by the hub member 30. The clearances c1, c2 provided between the retaining fastener 50 and the hub member surfaces allows the teeth 46 to move from the extended position shown in FIG. 4 to the retracted position shown in FIG. 5 and also allows each associated tooth 46 to “rock” to facilitate this movement. In other words, each tooth 46 is allowed to “rock” as it moves both axially and radially during its retraction and extension movement.

The teeth 46 are moved to their extended positions by the cone/cam 40 which is operatively connected to the piston or operating pin 36. As seen best in FIG. 4 when the cam/cone 40 moves to the right, its frusto-conical camming surface co acts with an associated curved cam surface 46a (shown best in FIG. 2) on each tooth 46 which causes the teeth to move outwardly as shown in FIG. 4. When the cam/cone 40 is moved to the right, the teeth are allowed to move inwardly to their retracted positions.

In the preferred and illustrated embodiment, the cam/cone 40 is urged towards the right (as viewed in FIGS. 4 and 5) i.e. to the teeth extending position by a biasing spring 60. In the preferred embodiment, the biasing spring 60 applies a force to the cam/cone 40 tending to apply extension forces to the teeth 46. In the preferred and illustrated embodiment, fluid or pneumatic pressure is applied to an effective pressure area 70 defined by an end face of the piston 36 to exert a force on the piston 36 that is greater than the spring force tending to retract the piston and, hence, moves the piston 36 and attached cam 40 to the position shown in FIG. 5. Alternately, an operating pin (not shown) or other suitable component can used to exert a force on the piston 36 that is greater than the spring force and thus move the piston to the left as viewed in FIG. 5

According to the preferred molding method, a sheet of suitable, heated material, i.e., PVC or other suitable plastic over the mold 10. The piston 36 and an associated cam/cone 40 are allowed to move to the right as viewed in FIG. 4 in order to extend the teeth 46 to their outward positions shown in FIG. 4. A vacuum is then applied to the tool 10 to draw down the plastic material in order to cause the material to be drawn into intimate contact with the tooling 10. The heated sheet of material thus takes the shape of the hub 10b and base plate 10a. In the preferred and illustrated embodiment, a vacuum is also applied to the effective pressure area 70 defined by an end face of the piston 36 to provide a force that is additive to the spring force applied by the spring 60 in order to maintain the position of the frusto-conical cam/cone 40 shown in FIG. 4. It should be noted that as the hub 20 of the shield 12 is being formed, the material will exert a force on the teeth 46 tending to urge the teeth 46 to their retracted position shown in FIG. 5. The vacuum applied to the end face 70 of the piston 36 increases the force on the teeth 46 tending to urge the teeth to their extended positions shown in FIG. 4.

The molded protective shield 12 is removed from the tooling by first releasing the vacuum force on the piston effective pressure area 70 and preferably an air pressure is applied to move the piston towards the left to the position shown in FIG. 5, allowing the teeth 46 to retract as the molded protective shield 12 is pulled or stripped from the tooling 10.

It should be noted that the present invention also contemplates the use of a spring or springs (not shown) to apply a direct retraction force on the teeth 46. This spring may comprise an annular spring or spring coil that is placed around the teeth which applies an inwardly directed radial force on each of the projecting teeth so that when the cam/cone moves to the left as viewed in FIG. 5, the teeth 46 are drawn inwardly by the teeth retraction spring.

Although the invention has been described with a certain degree of particularity, it should be understood that those skilled in the art can make various changes to it without departing from the spirit or scope of the invention as hereinafter claimed.

1. A tooling apparatus for forming a cylindrical hub portion in a protective cover, comprising:
a) a hub forming member secured to a base;
b) a reciprocally movable operating member slidably supported by said hub;
c) a camming element operatively attached to said operating member;
d) a plurality of radially extendable fingers held in associated pockets defined by said hub forming member;
e) each of said fingers defining a cam contact surface abutably engageable with said camming element, such that movement of said camming element towards said cam contact surfaces urges said fingers radially outwardly to thereby form projections in a protective cover molded by said tooling apparatus and such that when said camming element moves away from said cam contact surfaces, said fingers are allowed to retract to thereby release the molded hub portion of said protective cover.

2. The apparatus of claim 1 wherein said camming element is spring biased towards contact with said cam contact surfaces of said fingers.

3. The apparatus of claim 2 wherein said fingers are held in said hub pockets using a fastener that allows each finger to move radially and axially as the finger moves from a retracted position to an extended position.

4. The apparatus of claim 3 wherein said finger fastener extends through a bore defined by said hub which defines a radial clearance between a shaft of said fastener and said bore to provide a first clearance and said fastener is attached to its associated finger such that a clearance is defined between an underside of a head of said fastener and an end face of said bore.

5. The apparatus of claim 1 wherein said camming element includes a frusto-conical camming surface.

6. The apparatus of claim 1 wherein said operating member is also slidably supported by said base member.

7. The tooling apparatus of claim 1 wherein each of said pockets includes a pocket camming surface which is slidably engageable with an associated pocket cam contact surface formed on said finger such that when said finger is squeezed between said camming element and said pocket camming surface, said finger is urged radially outwardly.

8. The tooling apparatus of claim 2 wherein said camming element is spring biased by a coil spring.

9. The tooling apparatus of claim 7 wherein said camming element includes a frusto-conical camming surface, said pocket camming surface is radiused and said finger cam contact and pocket cam contact surface on said finger are radiused and substantially conform to the associated camming element surface and said pocket camming surface.

10. The tooling apparatus of claim 1 wherein said reciprocally movable operating member is movable between at least two positions, wherein in one position said fingers are retracted and wherein said other position said fingers are extended and said operating member being urged to at feast one of said positions by a source of vacuum communicated to an effective pressure area on said operating member.

11. The tooling apparatus of claim 10 wherein said operating member is urged to said at least one position by the combination of a spring force and said source of vacuum.

12. The tooling apparatus of claim 11 wherein said operating member is urged to its other position by a source of pneumatic pressure applied to said effective pressure area.

13. The tooling apparatus of claim 1 wherein said operating member defines a piston having an effective pressure area for applying forces to said operating member.
